(19) United States
(12) Patent Application Publication
(10) Pub. No.: US 2001/0017001 A1
(43) Pub. Date: Aug. 30, 2001

(54) Trap

(76) Inventor: Peter Leverton, West Yorkshire (GB)

Correspondence Address: MICHAEL BEST & FRIEDRICH, LLP, 100 E WISCONSIN AVENUE, MILWAUKEE, WI, 53202, US

(21) Appl. No.: 09/793,028

(22) Filed: Feb. 26, 2001

(30) Foreign Application Priority Data
Feb. 26, 2000 (GB) 0004513.8
Apr. 26, 2000 (GB) 0010026.3

(51) Int. Cl. A01M 1/10; A01M 23/00

(52) U.S. Cl. 43/58

(57) ABSTRACT

The invention describes a vermin trap 1 which comprises a length of wire which is bent to form a base 2, a neck 7 and a sharp, barbed point 4. A number of the traps 1 are embedded into a solid support 16 thereby forming an array 14. A number of these arrays 14 are inserted underneath a cover section to form a tunnel trap 18.

The present invention relates to a trap and particularly, although not exclusively, relates to a trap for catching or injuring rodents and/or vermin.

Traditional methods for killing rodents such as rats or mice include laying down bait which is dosed with poison, or laying down hinged traps which, when triggered, snap shut onto the rodent.

Problems arise with using poisoned bait in that it has to be frequently monitored and replaced and it is often undesirable to use poisons in certain areas which are visited by people or pets. There are disadvantages with using hinged traps in that they have to be set by hand which can be dangerous to the operator.

With a view to addressing the problems of prior art mentioned above, or otherwise, it is an aim of at least embodiments of the present invention to provide a trap for catching or killing rodents in which the potential of inflicting harm to the operator is reduced.

According to a first aspect of the present invention, there is provided a trap for the incapacitation of vermin, the trap comprising spike means and base means, the spike means being arranged substantially at an angle to the base means such that, in use, the spike means projects away from a surface on which the trap is placed to thereby impale a vermin on the spike means.

Preferably, the spike means extends substantially perpendicular to the base means.

Preferably, the spike means is manufactured from a single piece of material, preferably, tensile steel. Preferably, the piece of steel is elongate.

The spike means may have a flat, or alternatively, a circular cross-section and, preferably, comprises a central shaft region and two end regions either side of the shaft region. Each end region of the spike means may have a point and barb configuration. Alternatively, only one of the end regions of the spike means may have a point and barb arrangement. Advantageously, the barb reduces the likelihood of the spike means being removed from the vermin once impaled thereon.

In use, the trap may be embedded in any edible matter to form a pellet. The edible matter may be bait, chocolate or a bread dough mixture.

The base means may comprise a support means which may be integral or separate. The support means may be a block, which may be separate from the spike means having a plurality of apertures therein. Preferably, the block is more massive than the spike means.

Preferably, the or each aperture is located on the same surface of the block. Preferably, the dimension of each aperture is such that a substantial amount of the shaft region of the spike means may be accommodated therein.

Each aperture may accommodate a plurality of spike means. Preferably, each aperture accommodates one spike means. Preferably, the shaft region of the spike means fits substantially loosely within the or each aperture such that, following impaling into the body of the vermin, the spike means is pulled out of the aperture and retained within the body of the vermin.

In an alternative embodiment, a section of the material forming the spike means may be treated, preferably by bending, to form the base means. Preferably, the material is bent such that the central shaft region forms the base means and at least one end region of the material forms the spike means. The base means may be of any shape but it is preferably circular or square and substantially planar.

Preferably, the spike means project away from the plane of the base means.

Preferably, the spike means project away from the plane of the base means at an angle of approximately 90°.

Where there are a plurality of spike means, they may project away from the planar base means either in substantially the same direction or opposite directions from each other.

In the present embodiment, the base means may be secured to, or preferably, embedded into the support means. The support means may be a block, preferably, a solid block in which a plurality of traps may be embedded thereby forming an array of traps.

The array of traps may be substantially covered with cover means thereby hiding the spike means from the view of the vermin. Preferably, bait, oats or food may be placed onto the cover means to increase the attraction of the array to the vermin. The cover means may be a sheet of paper which is, preferably, sufficiently thin to allow the spike means to pass substantially therethrough upon the weight of the vermin.

The support means may be flexible and may be operable to be rolled into a roll. The support may be a rubber mat with a plurality of traps secured thereto, or, preferably, embedded therein which may be rolled up. Advantageously, such an embodiment allows easy transportation of the trap.

Preferably, at least one array of traps may be located under a cover portion.

The cover portion may comprise side walls and a roof. Alternatively, or additionally, the cover portion may form one member forming the side walls and a roof. The roof may be arcuate or substantially flat. Preferably, the cover portion forms a tunnel which is, preferably, open ended to allow entry by vermin.

According to a second aspect of the present invention, there is provided a method of incapacitating vermin, comprising placing at least one trap in a chosen location, said trap having spike means and base means, the spike means being arranged substantially at an angle to the base means, and allowing one or more vermin to become impaled thereon to thereby incapacitate the or each vermin.

All of the features disclosed herein may be combined with any of the above aspects in any combination.

For a better understanding of the invention, and to show how embodiments of the same may be carried into effect, reference will now be made, by way of example, to the accompanying diagrammatic drawings, in which:

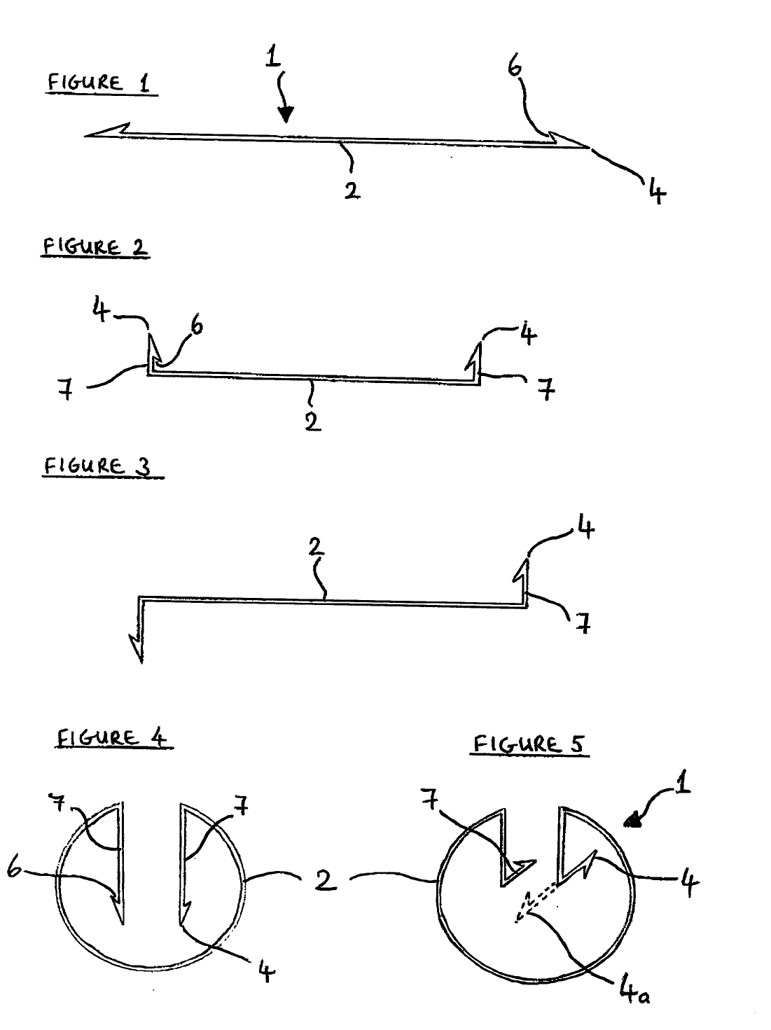

FIG. 1 is a schematic side view of a first embodiment of a vermin trap in a first configuration;

FIG. 2 is a schematic side view of the embodiment of FIG. 1 in a second configuration;

FIG. 3 is a schematic side view from above of the embodiment of FIG. 1 in a third configuration;

FIG. 4 is a schematic view from above of the embodiment of FIG. 1 partially formed into the configuration shown in FIG. 5;

FIG. 5 is a schematic view of the embodiment of FIG. 1 in a fourth configuration;

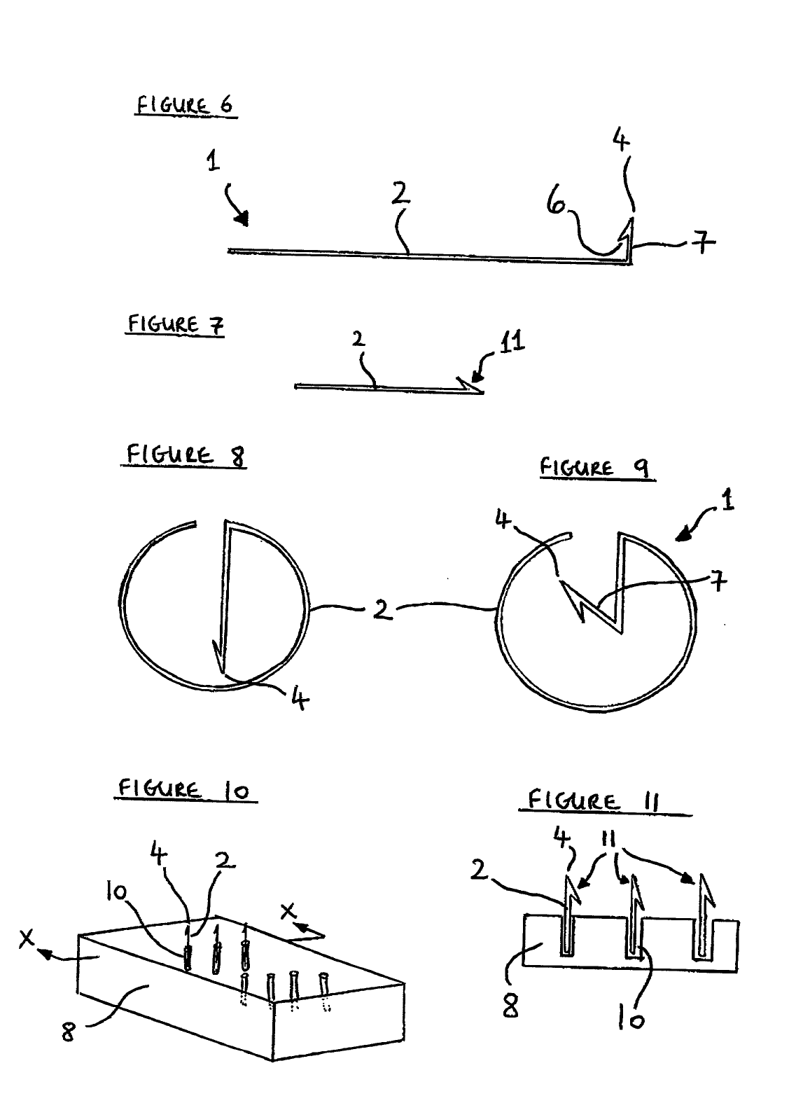

FIG. 6 is a schematic side view of a second embodiment of a vermin trap in a first configuration;

FIG. 7 is a schematic side view of the second embodiment in a second configuration;

FIG. 8 is a schematic view from above of the second embodiment in a third configuration;

FIG. 9 is a schematic view from above of the second embodiment in a fourth configuration;

FIG. 10 is a perspective view of a block arranged and used with the first and second embodiments of the vermin trap;

FIG. 11 is a schematic cross-sectional side view of the block along the line x-x shown in FIG. 10;

FIG. 12 is a perspective view of a support arranged and used with the first and second embodiments of the vermin trap; and

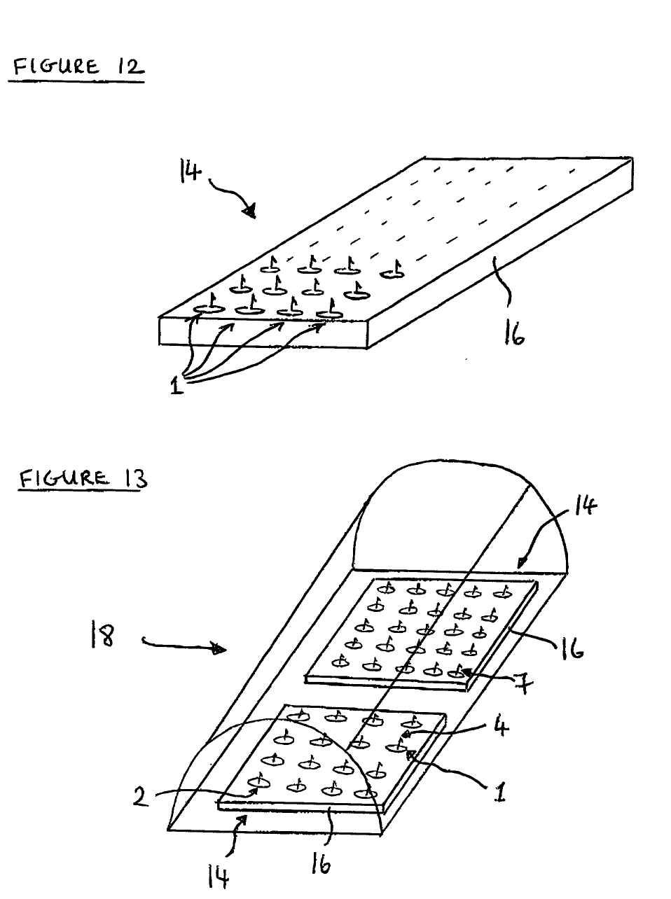

FIG. 13 is a perspective view of a tunnel trap arranged and used with the first and second embodiments of the vermin trap.

FIGS. 1 to 5 show a first embodiment of a vermin trap comprising a single length of wire 2 in a series of different configurations. Referring to FIG. 1, the vermin trap 1 is shown comprising the length of thin wire 2 with a sharp point 4 and barb 6 arrangement at each end. The wire 2 can be of any cross-section but will tend to be made of either flat or round tensile steel.

Referring to FIG. 2, the vermin trap 1 is shown with the two ends of the wire 2 bent to form neck regions 7 which form an angle of substantially 90° with the main length of wire 2. In this arrangement, the two points 4 face in substantially the same direction as each other.

Referring to FIG. 3, the vermin trap 1 is shown with the two ends of the wire 2 angled such that the points 4 face in substantially opposite directions to each other.

Referring to FIG. 4 which shows the trap part way through the process of making the configuration shown in FIG. 5, the vermin trap 1 has been bent into an open circle configuration, with the two points 4 of the wire 2 facing inwardly along the same plain as the rest of the circle. In FIG. 5, the two points 4 of the FIG. 4 configuration have been bent such that neck regions 7 are formed, and whereby the points 4 face away from the plain of the circle. The two points 4 may either face in the same direction or in the opposite directions away from the plain of the circle as shown by the dashed point 4a. When the points 4 face in the same direction, the circular region 2 acts as a base for the vermin trap 1 such that the two points 4 face upwardly.

In use, the trap 1 is placed in areas where vermin may be found such that unsuspecting vermin step onto the points 4 or so that the points 4 incapacitate the vermin in some way. The barbs 6 of the points 4 prevent the vermin from easily removing the point 4 from its body, causing substantial injury ultimately leading to death. Although not necessary, the points 4 may also be treated with poison to improve the efficiency of the vermin trap 1. It should be appreciated that, the wire 2 may be bent to form any shape (eg. circular, square etc) as long as the wire 2 forms a base such that the points 4 face in a substantially upwardly direction.

FIGS. 6-9 show the second embodiment of the vermin trap 1 in a series of different configurations.

FIG. 6 shows the vermin trap 1 in a similar configuration to FIG. 2, however, it only has one sharp point 4 and barb 6 bent to form an angle at substantially 90° with the length of wire 2.

FIG. 7 shows a spike 11 comprising a short straight length of wire 2 having a sharp point 4 pointing in the direction of the wire 2.

Referring to FIG. 8, the vermin trap 1 is shown partially formed into the configuration shown in FIG. 9. The trap 1 has been bent into an open circle configuration similar to that in FIG. 4. A single point 4 faces inwardly along the same plain as the rest of the circle.

FIG. 9 shows a configuration similar to that in FIG. 5; the point 4 has been bent such that a neck region 7 is formed whereby the point 4 faces in a direction away from the plain of the circle. The circular region 2 acts as a base for the vermin trap 1 such that the single point 4 faces upwardly. As with the first embodiment of the vermin trap 1, the second embodiment is placed in areas frequented by vermin so that they are exterminated. The vermin trap 1 may be made more attractive to vermin and hence increase the chances of killing the vermin by wrapping and, therefore, hiding the trap 1 in edible matter, such as bait or chocolate into a pellet which the vermin would readily eat.

Referring to FIG. 10, a rectangular block 8 is shown having a number of apertures 10 formed therein. The number and dimensions of the apertures 10 are such that they accommodate the spike 11 as shown in FIG. 7. The spike 11 is inserted into each aperture 10 such that at least the point 4 and barb 6 of each vermin trap 1 is exposed beyond the upper surface of block 8. The spikes 11 are fitted loosely into the apertures 10 such that when the vermin lands on one or more of the sharp points 4 the points 4 pierce the vermin's feet, legs or body etc. The spikes 11 are pulled out of apertures 10 as the vermin tries to escape. The barb 6 of each point 4 prevents the easy removal of spike 11 from the vermin.

The block 8 may also be used in conjunction with the embodiment shown in FIG. 5 in which the two points 4 face in substantially opposite directions away from the plain of the circle, ie point 4 and point 4a. In such an arrangement, one of the points 4, 4a is inserted into the aperture 10 allowing the other point to face substantially upwardly.

It will be appreciated that the barb 6 of the point 4, 4a inserted into the aperture 10 will prevent the vermin trap 1 from being pulled out of the aperture 10 by a rodent.

Referring to FIG. 12, a support 16 is shown having a series of rows of vermin traps 1 as shown in FIG. 9 secured thereto. The vermin traps 1 are either embedded into the support 16 or fixed thereon thereby forming an array 14 of traps 1. The array 14 can either be used as previously described or it may be more effective if a sheet of thin paper (not shown) is laid over it thereby hiding the points 4 from view of the vermin. Bait or other food such as chocolate etc may then be sprinkled over the paper to attract the vermin to the array 14. As the vermin mounts the paper to get to the bait, the weight of the vermin is sufficient to push it through onto the array of points 4 hidden thereunder thereby causing incapacitation and/or death. As with the previous embodiments, the array 14 may be even more attractive to the vermin by manufacturing the support 16 out of edible matter, for example, biscuit etc. Alternatively, the array 14 may be made more transportable by manufacturing the support out of a rubber mat which may be rolled up, transported to the desired site and then unrolled to expose the points 4.

Referring to FIG. 13, a tunnel trap 18 is shown having two of the arrays 14 fitted therein. The tunnel trap 18 is shown having an arcuate roof and two side walls. Since vermin are more accustomed to small, dark spaces, they are more prone to investigate such artificial tunnel traps 18. It should be appreciated that any of the embodiments of the vermin trap 1 could be placed inside the tunnel trap 18.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A trap for the incapacitation of vermin, the trap comprising spike means and base means, the base means comprising support means, the spike means being arranged substantially at an angle to the base means such that, in use, the spike means projects away from a surface on which the trap is placed to thereby impale a vermin on the spike means.

2. A trap according to claim 1, wherein the spike means is manufactured from a single piece of material.

3. A trap according to claim 1, wherein the spike means comprises a central shaft region and two end regions either side of the shaft region.

4. A trap according to claim 3, wherein each end region of the spike means has a point and barb configuration.

5. A trap according to claim 1, wherein the trap is embedded in any edible matter to form a pellet.

6. A trap according to claim 1, wherein the support means is a block which is separate from the spike means having a plurality of apertures therein.

7. A trap according to claim 6, wherein each aperture accommodates a plurality of spike means.

8. A trap according to claim 1, wherein the material is bent such that the central shaft region forms the base means and at least one end region of the material forms the spike means.

9. A trap according to claim 1, wherein the support means is a solid block in which a plurality of traps are embedded thereby forming an array of traps.

10. A trap according to claim 9, wherein the array of traps is substantially covered with cover means thereby hiding the spike means from the view of the vermin.

11. A trap according to claim 1, wherein the support means is a rubber mat with a plurality of traps secured thereto.

12. A trap for the incapacitation of vermin, the trap comprising spike means and base means, the base means comprising support means, the spike means being manufactured from a single piece of material and comprising a central shaft region and two end regions either side of the shaft region, each end region having a point and barb configuration, the spike means being arranged substantially at an angle to the base means such that, in use, the spike means projects away from a surface on which the trap is placed to thereby impale a vermin on the spike means.

13. A method of incapacitating vermin, comprising placing at least one trap in a chosen location, said trap having spike means and base means, the spike means being arranged substantially at an angle to the base means, and allowing one or more vermin to become impaled thereon to thereby incapacitate the or each vermin.
